(19) United States
(12) Patent Application Publication
(10) Pub. No.: US 2007/0255570 A1
(43) Pub. Date: Nov. 1, 2007

(54) Multi-platform visual pronunciation dictionary

(76) Inventors: Fawaz Y. Annaz, Fukui-shi (JP); Charles E. Jannuzi, Fukui-shi (JP)

Correspondence Address: LITMAN LAW OFFICES, LTD., P.O. BOX 15035, CRYSTAL CITY STATION, ARLINGTON, VA, 22215, US

(21) Appl. No.: 11/655,838

(22) Filed: Jan. 22, 2007

Related U.S. Application Data
(60) Provisional application No. 60/794,850, filed on Apr. 26, 2006.

(51) Int. Cl. G10L 21/00

(52) U.S. Cl. 704/270

(57) ABSTRACT

The multi-platform visual pronunciation dictionary is capable of cross-referencing words and phrases between a user's native language and a foreign language by presenting to the user a correct translation and pronunciation in a recorded video presentation by a native speaker of the foreign language. Monolinguistic cross-referencing may also be provided. The dictionary provides a user interface and lexical database designed to enable the learner to visualize and hear the target language. An electronic dictionary is provided and includes an interface with a visual display capable of playing high quality recordings showing a model speaker's face speaking the lexical item. The visual pronunciation dictionary has a plurality of high-quality synchronized video and sound recordings of a plurality of lexical items in a language spoken by a native speaker that is stored in a database and accessible by a user interface device. A dedicated SD-video-capable electronic dictionary may also be provided.

### CROSS-REFERENCE TO RELATED APPLICATION

This application claims the benefit of U.S. Provisional Patent Application Ser. No. 60/794,850, filed Apr. 26, 2006.

### BACKGROUND OF THE INVENTION

1. Field of the Invention

The present invention relates to a multi-platform visual pronunciation dictionary, i.e., a lexicon, which cross-references words and phrases of a language with synonymous definitions in the same language, or alternatively, cross-references words and phrases of the language with a foreign language translation. A correct translation and/or pronunciation are provided to the user in the form of a multimedia, recorded video presentation by a native speaker of the language.

2. Description of the Related Art

The printed dictionary has long existed for study and consultation while writing and editing as a reference for the proper use and meaning verification of native languages, second languages, and foreign languages. Thus far, the electronic dictionary has consisted of attempts to transfer the key elements of printed dictionaries (such as alphabetically-ordered lists of words with definitions) into electronic text with a searchable database underlying the user's interaction with the lexicon. The portable/mobile/handheld versions of the electronic dictionary have been of more interest in the teaching, learning, and study of second and foreign languages than in other areas (such as literacy in a native language). Typically such electronic dictionaries are dedicated units, with an integrated system of software and hardware greatly resembling a handheld computer, and which have only recently become available in forms that might accept additional content, such as through a copy-protected SD memory card.

Attempts at constructing multimedia (MM) capable pronunciation dictionaries in electronic media have consisted of linking lexicon entries to audio recordings of the words and phrases being pronounced, so that these efforts at MM, except for digitization and compression of audio files and their integration (such as hotlinks) with the text portion of the dictionary, are no different from the audio recordings that dominated audio-lingual (‘listen and repeat’) approaches to foreign language learning in the 1950s and 1960s. To the extent that attempts have been made to integrate video into foreign language instruction, such attempts have been limited to dramatizations with settings and characters performing actions and exchanging scripted language.

Thus, a multi-platform visual pronunciation dictionary solving the aforementioned problems is desired.

### SUMMARY OF THE INVENTION

The multi-platform visual pronunciation dictionary, i.e., lexicon, is a device that cross-references words and phrases between a user's native language and a foreign language by presenting to the user a correct translation, contextual use and pronunciation in the form of a multimedia, recorded video presentation by a native speaker of the foreign language.

Additionally, the present invention has the capability to monolinguistically cross-reference words and phrases in a specified language with synonymous words and phrases. The multi-platform visual pronunciation dictionary of the present invention provides a user interface and lexical database designed to enable the learner to visualize and hear the target language.

The multi-platform visual pronunciation dictionary provides an electronic dictionary that includes an interface with a visual display capable of playing high-quality recordings showing a model speaker's face while providing both a visual and audible pronunciation of a syllable, word, phrase, or clause. The visual pronunciation dictionary may be stored in a database in the form of a plurality of high-quality synchronized video and sound recordings of a plurality of lexical phrases in a language spoken by a native speaker, and accessed by a computer program. Preferably, the multi-platform visual pronunciation dictionary can be adapted and ported to a variety of devices, including computers, handheld computing devices, and handheld communications device, such as PDAs, mobile phones, electronic game machines, and the like. It is also within the scope of the present invention to provide an info-appliance, such as a dedicated electronic dictionary capable of video playback, e.g., an SD-video-capable device.

The multi-platform visual pronunciation dictionary (VPD) of the present invention provides a searchable database of words, via multiple pathways, in one or more languages (such as English, English-Japanese, etc.). Once accessed, a word that is displayed textually can then be used to activate the recorded audio-visual entries of the word in the lexicon/lexical database.

The underlying premise of the multi-platform visual pronunciation dictionary is that listening to a foreign language, by itself, is insufficient to learn the proper phonological and/or phonetic pronunciation of a foreign language, and that it is necessary to view and study the facial movements that precede and accompany the foreign word or phrase as spoken by one fluent in the native language in order to learn the proper pronunciation of the foreign language. The purpose of the VPD is not only to integrate the use of AVs with focused language learning, but, in a linguistically and psycho-linguistically enlightened manner, to present the visual, facially salient articulatory gestures (FSAG) of speech that indicate and represent the neural and muscular control, which necessarily underlies phonologically-controlled and phonetically-realized speech. In other words, without the reality of the visuals of speech, the auditory aspects are unexplained artifacts that might not provide sufficient input and feedback for a learner to acquire a second or foreign language. Such a use of MM functions would better reflect the adaptation of modern technology to language learning in light of how humans acquire their native language, e.g., by mimicking a caregiver in a face-to-face encounter.

These and other features of the present invention will become readily apparent upon further review of the following specification and drawings.

### BRIEF DESCRIPTION OF THE DRAWINGS

FIG. 1 is a diagrammatic view of an exemplary user interface of the multi-platform visual pronunciation dictionary according to the present invention with the feedback control off.

FIG. 2 is a diagrammatic view of an exemplary user interface of the multi-platform visual pronunciation dictionary according to the present invention with the feedback control on.

FIG. 3 is a diagrammatic view of an interface for gender and age selection in a multi-platform visual pronunciation dictionary according to the present invention.

FIG. 4 is a first exemplary branching tree diagram for the multi-platform visual pronunciation dictionary according to the present invention in category dictionary mode.

FIG. 5 is a second exemplary branching tree diagram for the multi-platform visual pronunciation dictionary according to the present invention in category dictionary mode.

FIG. 6 is an exemplary diagrammatic view of window display page options in a multi-platform visual pronunciation dictionary according to the present invention.

FIG. 7 is an exemplary diagrammatic view of a mouth comparison page of a multi-platform visual pronunciation dictionary according to the present invention.

FIG. 8 is an exemplary diagrammatic view of mouth convergence page of a multi-platform visual pronunciation dictionary according to the present invention.

FIG. 9 is an exemplary diagrammatic view of the hardware configuration of a device capable of loading and executing a multi-platform visual pronunciation dictionary according to the present invention.

Similar reference characters denote corresponding features consistently throughout the attached drawings.

### DETAILED DESCRIPTION OF THE PREFERRED EMBODIMENT

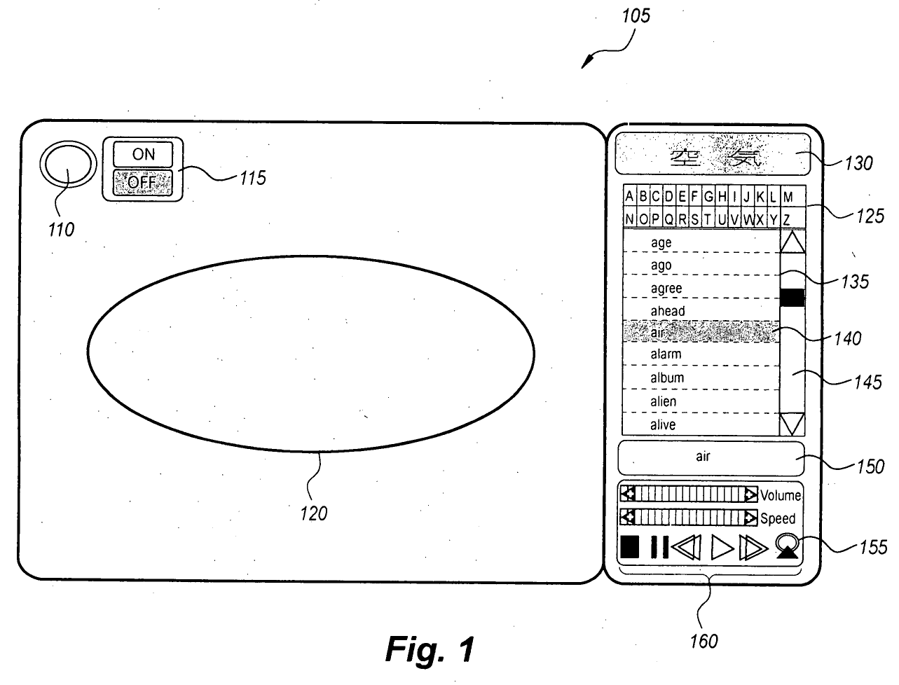

As shown in FIG. 1, the multi-platform visual pronunciation dictionary (VPD) 105 is a device that may cross-reference words and phrases between a user's native language and a foreign language by presenting to the user a correct translation and pronunciation in the form of a multimedia, recorded audiovisual presentation by a native speaker of the foreign language. Alternatively, the present invention can cross-reference words and phrases in a specified language with synonymous words and phrases in the same language. That is to say, the cross-reference of words and phrases may also be monolinguistic.

The visual pronunciation dictionary 105 utilizes only native speakers having the capability to deliver a fluent, phonologically and syntactically complete form of the language to be recorded in the video presentation. As shown in FIGS. 1, 2 and 9, the multi-platform visual pronunciation dictionary 105 of the present invention provides a user interface having a lexical database 905 designed to enable the learner to visualize and hear a target language.

The multi-platform visual pronunciation dictionary 105 provides an electronic dictionary that includes an interface with a visual display, which is capable of playing high-quality synchronized video and sound recordings of a plurality of lexical items in a language spoken by a native speaker and stored in a first database (the video and sound recordings may be stored in any desired storage location, and the database may store and return the file location of the video and audio recordings with an executable link to the file location). The video recording focuses on the native speaker's face during the audio-visual presentation of a syllable, word, phrase, or clause pronunciation. A cross-reference to the plurality of lexical items is stored in a second database. The cross-reference comprises a plurality of lexical items in a language that the user is familiar with. Databases containing the languages may be stored in separate storage units or in the same storage unit, such as database storage unit 905. Alternatively, the foreign language phrases and the user language phrases may be stored in two tables of a single relational database 905. When the user selects a lexical item in his own language, the VPD 105 plays back the high-quality synchronized video and sound recording of a corresponding lexical item in the foreign language based on the cross-reference.

In addition to the basic pronunciation feature of the VPD 105, a vocabulary study module having a vocabulary study template may also be provided, which extends the utility of VPD 105 to such areas as remedial reading and word study, and may include such features as phonetic spellings, syllabic breaks with stress or pitch marks, bilingual translation, monolingual definitions, synonyms, antonyms, polysemy, key collocations, patterns and examples of inflectional and derivational morphology, and example idioms, phrases, and sentences.

The visual pronunciation dictionary 105 may be stored in the database 905 and accessed by a computer program being executed by a processor 900. Processor 900 is a general purpose computing device that may have a variety of form factors and computing power. Thus, the multi-platform visual pronunciation dictionary 105 can be adapted and ported to a variety of devices, including desktop computers, handheld computing devices, and handheld communications devices, such as PDAs, mobile phones, and the like.

It is also within the scope of the present invention to provide an info-appliance, such as a dedicated electronic dictionary capable of video playback, e.g., a Secure Digital flash memory card based, i.e., SD-video-capable, device.

As shown in FIG. 1, a default menu comprising a word letter index 125, a “target language” word meaning box 130, a word list 135 from which a word may be selected, as shown at 140, a scroll bar 145, a word search entry text box 150, a speaker select icon 155, and functionality controls, such as controls 160 to advance, rewind, pause, and stop playback of the audio-visual presentation of the pronunciation of the foreign language word or phrase may be provided. Alternative embodiments of the default menu may include a selection capability of dictionary modes, which includes a normal mode, a selective mode and/or a category mode. A level may also be selected that is appropriate to the user's language ability.

As indicated above, the executable functions 160 may include the functions of ‘play’, ‘pause’, ‘replay’, ‘next word selection’, ‘previous word selection’, ‘entry highlighting’, ‘entries scrolling’, ‘pronunciation speed adjustment and control’, ‘volume adjustment and control’, and ‘contrast adjustment and control’. In addition, the default menu may be coordinated with one or more languages selected depending on needs of the user, as compatible with hardware, software, memory, visual and audio playback capabilities of the VPD platform 105.

Thus, as shown in FIGS. 1, 2 and 9 the user interface comprises tactile and aural inputs and outputs, such as keyboard 910, display 915, camera 920, loudspeakers 927 and microphone 925. In addition, a software-generated component of the user interface comprises the default menu, native speaker's mouth detail area 120, camera ON indicator 110a, camera OFF indicator 110, camera ON switch 115a, and camera OFF switch 115, all presented on the display 915.

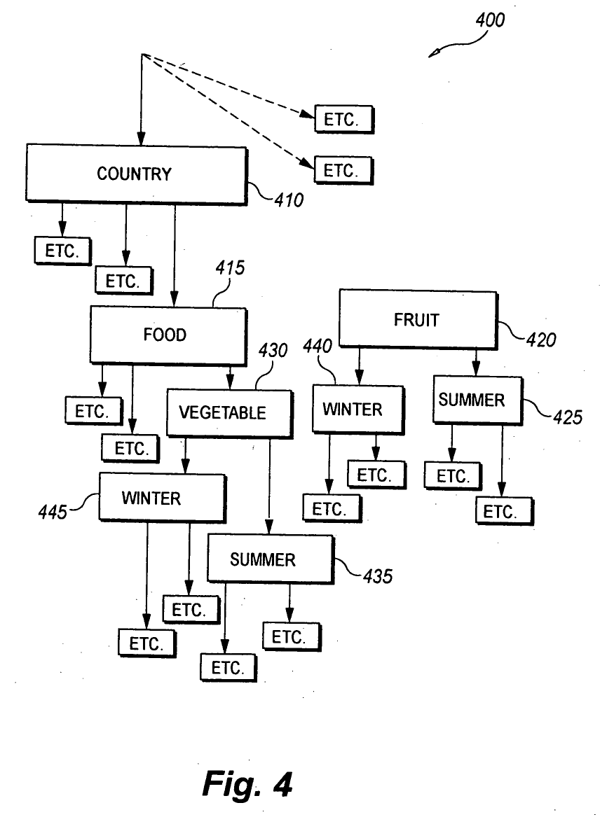

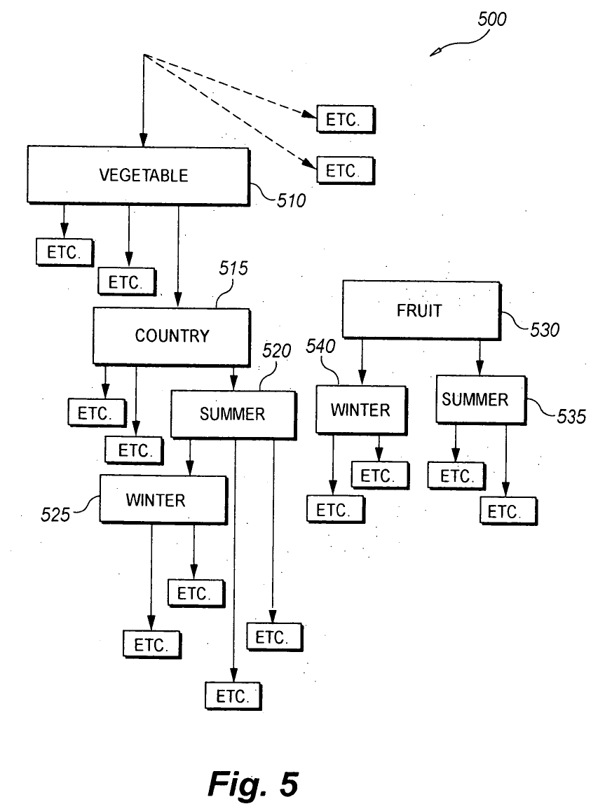

As shown in FIGS. 4 and 5, the visual pronunciation dictionary (VPD) 105 of the present invention provides a searchable database 905 of a plurality of lexical items, e.g., words and phrases, which can be searched via multiple pathways in one or more languages (such as English, English-Japanese, etc.).

For example, a first branching tree 400 in category dictionary mode of the present invention may have at a top level the category Country 410. Country 410 represents a country of the target language to be searched. The database 905 is arranged so that when Country 410 is selected and Food 415 is selected, the scope of searches required to be performed by processor 900 is limited to items related to foods that may be found in a country, such as the selected Country 410. A relational database is provided to increase speed and efficiency of the target language item lookups.

As further illustrated in FIG. 4, the relations can be restricted to Fruit 420, then Winter 440 for fruits that are available in the winter, or Summer 425 for fruits that are available in the summer. The same relational targeting of phrase lookups may be applied to other attributes of Food 415, such as Vegetable 430, and the like.

Alternatively, as shown in the tree 500 of FIG. 5, if the user first selects a Vegetable 510, the preferably relational database 905 may be used to narrow the categories down using context filters Country 515 or Fruit 530, then further limiting the context of target phrase lookups by narrowing the categories down to Summer 520 (under Country 515), Winter 540 (under Fruit 530) or Summer 535 (under Fruit 530), and the like.

Once accessed, an item that is displayed textually can be used to activate the audio-video entries, i.e., high-quality synchronized video and sound recording of the word in the lexicon/lexical database 905. For example, by typing the word ‘apple’ in search text entry box 150 and hitting ‘enter’ key on keyboard 910 or hitting a ‘search’ button provided elsewhere on the user interface of VPD 105, a user can watch in video screen area 120 a facial close-up of a native speaker of English saying the word, ‘apple’, simultaneously with hearing the utterance. The audio may be provided by loudspeakers 927, or ear phones, headphones, and the like. This type of interaction can be controlled from the user interface of the VPD 105 for forward, backward, normal, slow motion, frame by frame, and repeat playback.

In addition to typed entry in the search feature, the user can roam a pointing device and/or scroll up and down, page by page, searching a monolingual or bilingual textual word index, which then ‘hot links’ to the same database 905 of audio-video files of the lexicon. Again, once accessed and selected, the word can be used to call up and play a cross-referenced multimedia audio-visual file comprising a high-quality synchronized video and sound recording of a native speaker pronouncing the word.

The searchable database 905 is accessible via the various dictionary modes. The normal dictionary mode functions like a traditional dictionary, having the lexical phrases chosen by a user specification, such as typing in a word for playback. A syllabic and word dictionary mode provides entries grouped in the form of syllable types or words, as specified and enumerated by the user.

An analytic dictionary mode has entries in the database 905 grouped in the form of syllable types, words, phrases and sentences, enabling the user to access each type of entry independently. As shown in FIGS. 4 and 5, the category dictionary mode provides entries grouped in specified, narrowed-down scope, such as topic, semantic field, communicative function, or other principles of selection for presenting, studying and learning a vocabulary. The category dictionary has the capability to support better lexical learning by providing hyperlinks to synonyms, antonyms, polysemous entries of the same word, key collocations, hyponyms, hypernyms, and equivalents in a variety of languages.

Words in the database may be accessed in a variety of ways. However, inclusion of real-time accessible high-quality synchronized video and sound recordings of a language's lexicon advantageously enables the user to reinforce natural, correct pronunciation and repeated exposure for better language learning.

The VPD 105 can also be configured in a particular bilingual form for foreign or second language learners (such as English and Spanish, English and Japanese, English and French, etc.). When a user accesses or selects a word, the user interface can present the word textually in a standard spelling, in variants, in phonetic symbols with syllable breaks, e.g., International Phonetic Alphabet (IPA) symbology, and the like, in order to provide a written form that is more transparent with respect to pronunciation, bilingual translation, lexical understanding, and illustrative examples of the word, such as used in common collocations, phrases and sentences.

For example, many learners of English as a foreign language (EFL) cannot decipher English spelling of words encountered in print or e-text, thus causing a breakdown in their ability to remember the word or to pronounce the word intelligibly.

If the language being studied phonologically differs significantly from the learner's known language, audio alone may not be sufficient for them to make articulatory sense of a lexical item. Therefore, the VPD 105 provides a coordinated, tightly integrated audio and visual presentation of a target language to be learned by the user. The integrated multimedia presentation provided by the VPD 105 more closely reflects natural language learning processes, thereby reinforcing rather than distracting from foreign language learning.

The lexical database 905 and access system of the visual pronunciation dictionary 105 permits the user to access a monolingual or multilingual version of a lexical item (word or phrase) in e-text form. In addition, the VPD 105 is capable of providing a monolingual explanatory gloss, synonymous wording, a bilingual or multilingual translation, a text-based spelling and pronunciation, and sentences illustrating the use of the item along with more commonly occurring collocations of the item.

In addition, the VPD 105 may provide the user with the capability to see the native speaker's face from a user selectable viewing angle on viewing screen 120 contemporaneously with hearing the audio presentation. Thus, the user may glean different insight in how to correctly pronounce the word by changing the viewing angle to more clearly demonstrate a visual, facially salient articulatory gesture (FSAG) of speech as the word is being pronounced.

For example, a different viewing angle may more clearly display a protrusion or retraction movement of the speaker's mouth. The different camera viewing angles provided may include an orthogonal or elevational front view of the entire face, an orthogonal or elevational front view that focuses on a box that includes the nose, the upper jaw, the mouth, and the lower jaw, a perspective view from the left side, a perspective view from the right side, and the like.

The variety of playback modes, i.e, viewing angle, and playback mode, provided by the VPD 105 is based on the learning paradigm that a first acquisition of a lexical item, i.e., word or phrase is preferably achieved in face-to-face interaction with the speaker of the lexical item, language construct, and the like. VPD 105 provides a natural acquisition process similar to the process undergone to become native speakers of a language.

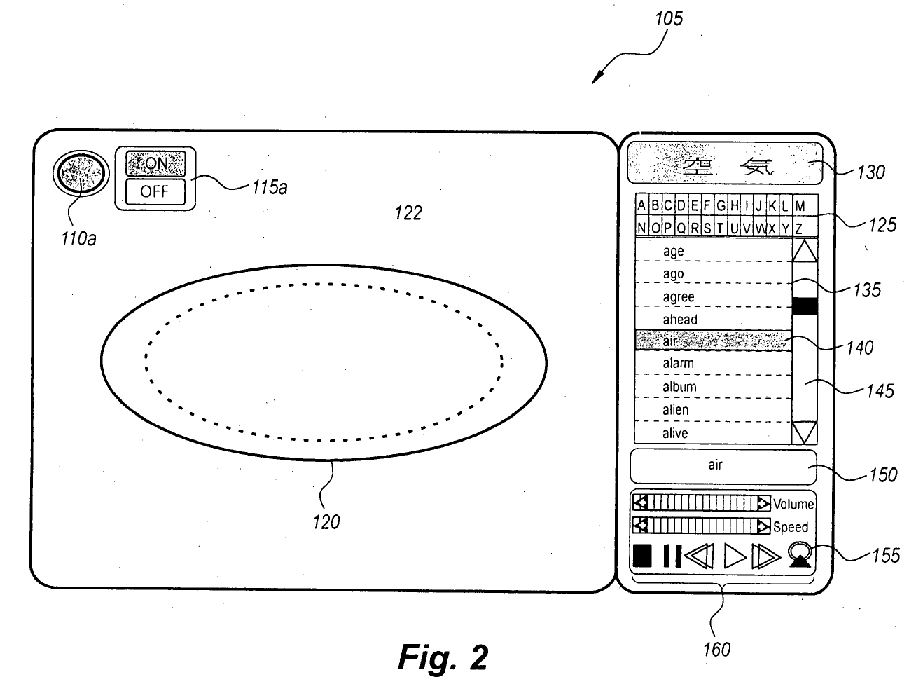

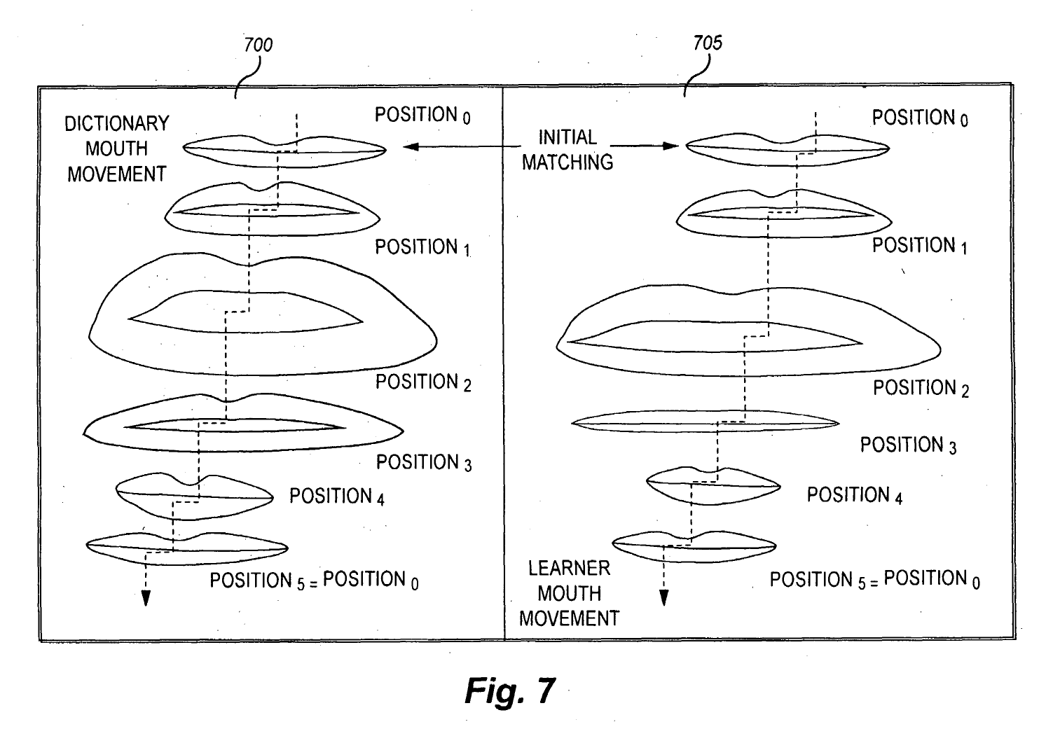

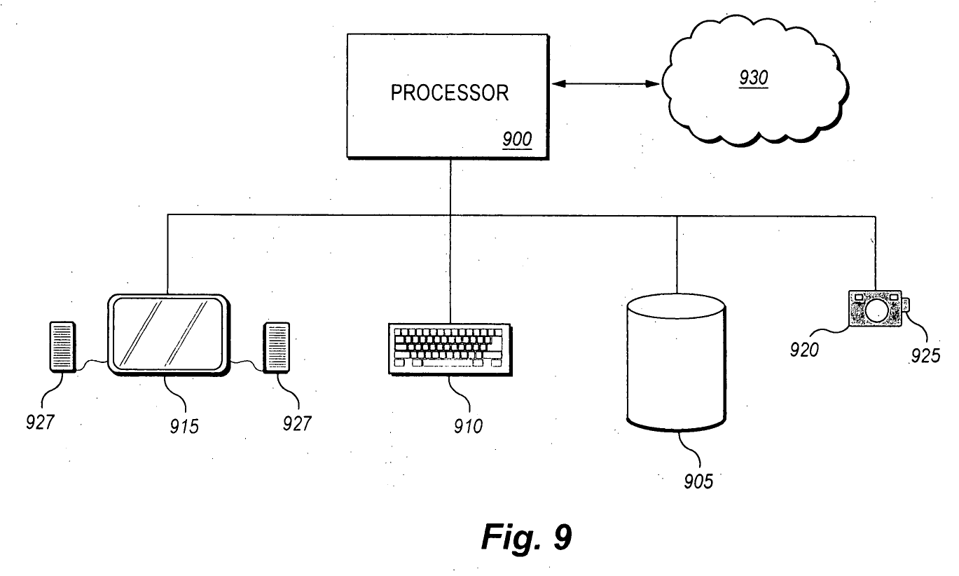

In addition, audio-visual (AV) feedback may be provided to enhance user acquisition of the lexical items presented by the VPD 105. As shown in FIGS. 2 and 9, the video camera 920 may be included in a VPD platform 105 to provide the AV feedback. The camera 920 may be selectable through icon 115a, shown in the ON position. Camera indicator 110a is presented when the camera 920 is activated. The VPD 105 has the capability to acquire, in real-time, user audio picked up by microphone 925, as well as user video from camera 920. The real-time user data acquisition capability is present contemporaneously with the real-time playback of native speaker recordings. As most clearly shown in FIG. 7, the VPD 105 has the capability of presenting the native speaker recording and the user data in a split screen format, comprising dictionary mouth movement, i.e., native speaker mouth movement screen 700 and user, i.e., learner, mouth movement screen 705. Moreover, the VPD 105 has the capability of presenting the native speaker recording and the user data in a transparent overlay format, comprising dictionary mouth movement, i.e., native speaker mouth movement screen 700 and user, i.e., learner, mouth movement screen 705. The real-time presentation of native speaker data and user data in a split screen format permits the user to make adjustments to the user's mouth movements in order to more closely mimic the native speaker's mouth movement. Thus, the feedback capability of the present invention can accelerate a learning process when the user attempts to acquire the lexical phrases presented by the VPD 105.

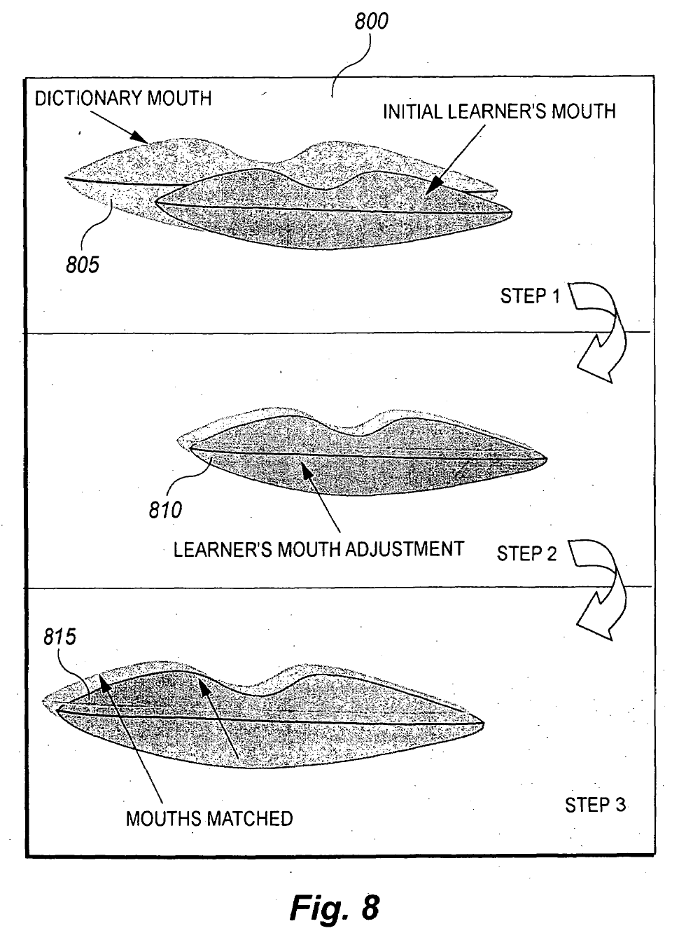

As shown in FIG. 8, the VPD 105 may also be provided with the capability to compare in real-time the native speaker data against the user data and display in an overlay fashion “mouth movement matching”, i.e., divergence or convergence of the two visual data streams, as appropriate, thus further enhancing positive learning feedback that the user experiences when utilizing the VPD 105. Referring again to FIG. 8, it should be noted that an initial mismatch 805, i.e., divergence, may be displayed. Subsequently when the user adjusts his/her mouth to more closely approximate the dictionary mouth, the two mouth images approach convergence 810. Mastery of the lexical item is displayed when the user mouth image finally converges on the dictionary mouth image, i.e., mouths matched 815.

While the VPD 105 preferably utilizes high quality synchronized video and sound recordings of lexical items to store and present the phrases and their associated facially salient articulatory gestures (FSAGs) of speech, it is within the contemplation of the present invention to provide storage and playback of various sub-lexical units of language including, but not limited to, vowels, vowel dipthongs, consonants, consonant clusters, phonetic vowels that act like phonemic consonants, phonetic consonants that act like phonemic vowels, onset-rime combinations, phonetically realized syllable types, articulatory gestures, and the like. Linguistic types capable of being isolated at a phonological-morphological interface may also be included for storage and retrieval.

In addition, sub-lexical units, such as those found in levels of linguistic analysis provided by morpho-phonemics, morpho-syllabics, phono-tactics, grammatical inflection, and lexical derivation, largely as distinct processes and phenomena separate from considerations of lexical meaning, super-lexical syntax, and discoursal semantics, may also be included for recording and playback of the VPD 105 for enhancement of the language learning experience of the user.

Still photographic and pictorial representations, i.e., recordings of a native speaker are also contemplated by the VPD 105, and may be added to the database 905 for retrieval associated with the aforementioned lexical and sub-lexical constructs.

It should be noted that all of the aforementioned lexical constructs, sub-lexical constructs, and associated video, still photographic, and pictorial data may be analyzed, organized in database 905, and presented in the form of an electronic dictionary that synchronizes a high quality visual close-up of the native speaker's face simultaneously with the spoken word or lexical phrase presented in high quality audio.

Moreover, limited only by platform hardware, memory, and processing power, the lexical database 905 may comprise an entire described lexicon of a language, which may comprise hundreds of thousands of types.

The lexical database 905 may also provide a substantial number of types tokens, i.e., examples of a word or phrase in actual use, extracted from a corpus database. For the purposes of the learner and/or the limitations of hardware and memory (e.g., portable devices), the accessible database can be limited to subsets of types (e.g., words) and tokens, i.e., instantiations of words, in a searchable, accessible master list/database, reflecting linguistic or pedagogical principles, such as word frequency (i.e., the first 800 words of a syllabus—a beginning level—or the 3800 most common words of a language, which would account for 80-90% of an authentic text), the specific requirements of a course or education system's syllabus (e.g., the first three years of EFL vocabulary required by a national education system), the vocabulary specific to a profession, vocation or activity (e.g., Ogden's list of Basic English for science and technology, medical English for doctors, nurses and technicians, English for vocational purposes, English for a factory assembly line workers, or situational English words and phrases for travel abroad).

In addition to the relational database 905, the VPD 105 provides a language analysis capability that can compile and arrange lists of words to sufficiently capture a lexis and organize it as a way of systematically viewing language at the levels of the word or lexical item, phrase, key uses and collocations. For some database entries, language analysis is provided at the lexical-sublexical interface for the specification of syllables or typical categorical sounds as types or units. Such units, once specified and enumerated, may also be linked to corresponding multimedia recordings for learner training.

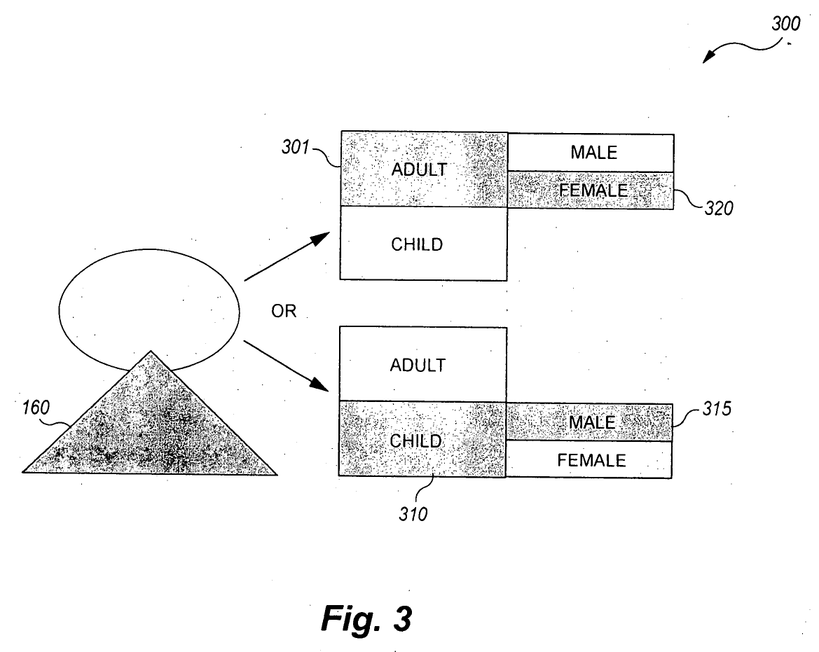

Multimedia recordings of the same items can be provided with alternative pronunciations, based on different dialects and accents, gender, or age of the speaker. As shown in FIGS. 1 and 3, a speaker select icon 155 is provided to open a gender, age selection menu 300. Selection menu 300 is preferably of the pulldown type. When a pointing device points over ADULT 301, either an adult male may be selected, or as shown, an ADULT 301 FEMALE 320 is selected. A user may initiate the same process to select either a CHILD 310 and FEMALE 320, or CHILD 310 and MALE 315. It is within the scope of the VPD 105 to provide similar selection menus for regional dialects, accents, and the like.

In addition to individual lexical items and sub-lexical units, the database 905, having textual and AV data, can include multimedia recordings of native speakers using words or phrases in illustrative sentences.

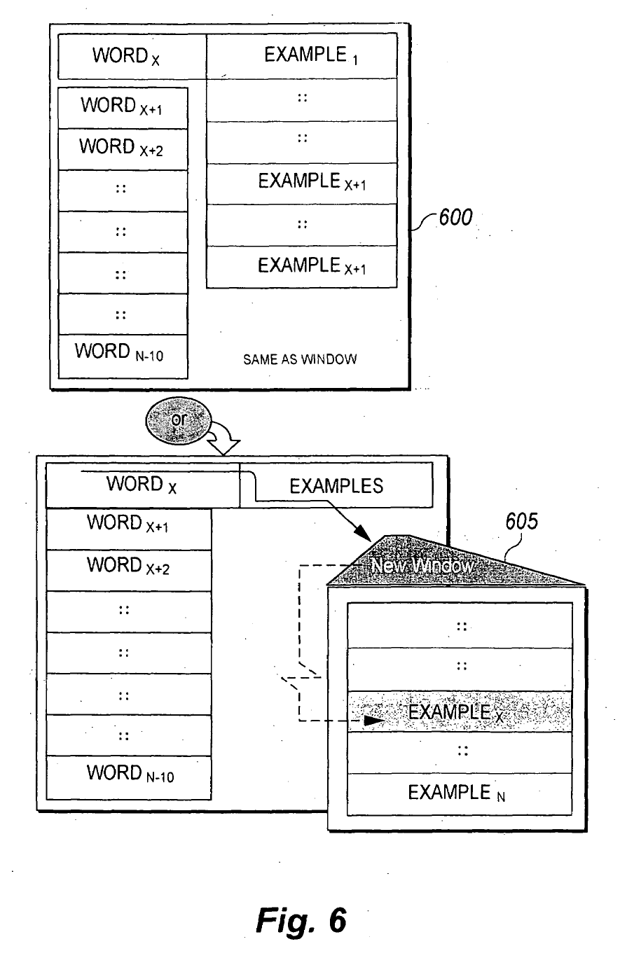

Additionally, pedagogically useful sentences can be constructed based on common collocations or selected from an existing corpus, reflecting a sample of actual past uses of a word and collocations. As shown in FIG. 6, textual presentation of a plurality of words may be displayed side by side with example related sentences and phrases in window 600. Alternatively, a separate window 605 is used to display the related sentence and phrase examples.

While actual high-quality synchronized video and sound recordings of a plurality of lexical phrases spoken by a native speaker is the preferred presentation method of the VPD 105, simplified and stylized versions of a visual articulatory gesture comprising animated sequences built up from photographic stills or cartoon faces may also be provided. These animated sequences have the capability to highlight, as a process, the key visual features of speech (such as a vowel with lip rounding, transitioning to a consonant with lips pursed, and the like).

It is within the scope of the present invention to provide the VPD 105 with the capability to run on a variety of computing and/or programmable communication devices having visual displays. Desktop and notebook computers may run the software from a combination of internal hardware and memory, and any other storage device, such as CD, DVD, and the like.

Software of the present invention may run on a stand-alone device having connectivity to, or loaded in, a port drive of the unit. Again, referring to FIG. 9, the ability to run on any computer, limited only by the scope of the lexical database available, may be included by providing a plug-in version of the software that runs from any Internet-capable device, such as processor 900 with modern web-browsing software. Additional word sets could be accessed and/or downloaded over a local network or the Internet. In addition, a plurality of VPDs 105 may be configured for multi-user, networked functionality, either via local network, Internet, or broadcast. A multi-user configuration has the capability to support downloading and accessing of additional content, i.e., additional lexicons, and to support the coordinated use among multiple users.

A particular embodiment of the VPD 105 has an interface that is scaled to run as an application or applet on a handheld/palmtop computer (HHPC), personal digital assistant (PDA), or any other info-appliance with visual display, user interface, and multimedia capabilities.

Moreover, the VPD 105 can be adapted or ported to even smaller hardware with visual displays, sufficient controls, and the ability to be programmed and accept new content, such as mobile/cellular phones, electronic game devices, handheld electronic dictionaries, and other various info-appliances having the capability to accept copyrighted content, and copy-protected memory devices, such as SD memory cards containing SD-audio, SD-video, and the like.

A ‘universal type’ of VPD 105 may be provided having a copy-protected, stand-alone set of folders, files directories and data comprising the word/dictionary lexicon, bilingual translations and sentence examples packaged in compressed AV files. The universal type VPD may be executable on any type of multimedia enabled personal computer having a configuration as shown in FIG. 9, wherein the database 905 may be contained in CD-ROM, DVD-ROM DVD-RAM, flash memory, memory stick, SD memory card, and the like. The universal type VPD is operating system independent. The user interface may be configured as a plug-in or applet capable of operable communication with a universal Internet browser, such as Microsoft® Internet Explorer® to make the VPD 105 operable in a variety of environments, i.e., WAN, LAN, WIFI, and the like. A VPD 105 of the universal type may be integrated with third party applications, so that the VPD 105 is capable of pronouncing matching entries from the third party applications, thus providing a “presentation assistant” functionality.

An ‘Installed Type’ of VPD 105 may be executable as an application on the main storage system and operating system of a multimedia-enabled personal computer, laptop computer, notebook computer, handheld computer/PDA, palmtop PDA or other mobile/portable computing device. The ‘installed type’, once loaded and installed may be executable for a single user on a stand-alone computer, but may also be enabled to request and accept new content over a classroom or local network, or through a designated website on the Internet.

An ‘integrated type’, i.e., ‘dedicated platform type’ of VPD 105 may be loaded from inserted, recognized, copy-protected memory media. The ‘integrated type’ of VPD 105 may be controlled and executable on multimedia-enabled handheld computing or communications devices, which have a visual display and audio functions having the capability to play audio-visual multi-media files. Preferably the device hosting the ‘integrated type’ VPD 105 can accept new content in a variety of formats, including copy-protected SD-Audio, SD-Video, and the like. Examples of integrated type VPD 105 hosting devices include game devices, mobile/cellular phones, dedicated handheld electronic dictionaries, and the like.

It is to be understood that the present invention is not limited to the embodiment described above, but encompasses any and all embodiments within the scope of the following claims.

We claim:

1. A multi-platform visual pronunciation dictionary, comprising:
a computer readable storage medium having a plurality of synchronized video and audio recording files of a plurality of words in a first language spoken by a native speaker of the first language stored thereon;
a database having a cross-reference table stored therein referencing words in a second language to a corresponding dictionary translation in the first language and to an executable link to one of the synchronized video and audio recording files having a correct pronunciation of the dictionary translation in the first language; and
means for playing back the dictionary translation video and audio recording file with focus on facial gestures, muscular movements, and lip movements of the native speaker in order to learn proper pronunciation in the first language.

2. The multi-platform visual pronunciation dictionary according to claim 1, wherein the synchronized video and audio recording files comprise recordings of sub-lexical units of language including:
vowels;
vowel dipthongs;
consonants;
consonant clusters;
phonetic vowels that act like phonemic consonants;
phonetic consonants that act like phonemic vowels;
onset-rime combinations;
phonetically realized syllable types; and
articulatory gestures.

3. The multi-platform visual pronunciation dictionary according to claim 1, wherein the synchronized video and audio recording files comprise recordings of lexical items, the lexical items being words and phrases.

4. The multi-platform visual pronunciation dictionary according to claim 1, wherein the synchronized video and audio recording files comprise recordings of linguistic forms capable of being isolated at a phonological-morphological interface.

5. The multi-platform visual pronunciation dictionary according to claim 1, wherein the synchronized video and audio recording files comprise recordings of sub-lexical units selected from the group consisting of morpho-phonemics, morpho-syllabics, phono-tactics, grammatical inflection, and lexical derivation.

6. The multi-platform visual pronunciation dictionary according to claim 1, wherein the synchronized video comprises a still visual representation of the audio recording file.

7. The multi-platform visual pronunciation dictionary according to claim 1, wherein the database comprises an entire described lexicon of a language.

8. The multi-platform visual pronunciation dictionary according to claim 1, wherein the database is a relational database and capable of being limited to subsets of types and tokens in a searchable and accessible master list reflecting a predetermined linguistic/pedagogical principle.

9. The multi-platform visual pronunciation dictionary according to claim 1, further comprising a vocabulary study module having a vocabulary study template means for providing remedial reading and word study, including phonetic spellings, syllabic breaks with stress/pitch marks, bilingual translation, monolingual definitions, synonyms, antonyms, polysemy, key collocations, patterns, examples of inflectional and derivational morphology, and example idioms, phrases, and sentences.

10. The multi-platform visual pronunciation dictionary according to claim 1, further comprising means for presenting the native speaker recording in split screen with a user for comparing mouth movements of the native speaker to mouth movements of the user in real time in order to provide the user a feedback language learning experience.

11. The multi-platform visual pronunciation dictionary according to claim 1, further comprising means for presenting the native speaker recording in a transparent overlay with a user for comparing mouth movements of the native speaker to mouth movements of the user in real time in order to provide the user a feedback language learning experience.

12. A multi-platform visual pronunciation dictionary, comprising:
a computer readable storage medium having a plurality of synchronized video and audio recording files of a plurality of words in a specified language spoken by a native speaker of the specified language stored thereon;
a database having a monolinguistic cross-reference table stored therein for cross-referencing words and phrases of the specified language to synonymous words and phrases from the same specified language and to an executable link to one of the synchronized video and audio recording files having a correct pronunciation of the synonymous words and phrases; and
means for playing back the synchronized video and audio recording file with focus on facial gestures, muscular movements, and lip movements of the native speaker in order to learn proper pronunciation in the specified language.

13. The multi-platform visual pronunciation dictionary according to claim 12, wherein the synchronized video and audio recording files comprise recordings of sub-lexical units of language including:
vowels;
vowel dipthongs;
consonants;
consonant clusters;
phonetic vowels that act like phonemic consonants;
phonetic consonants that act like phonemic vowels;
onset-rime combinations;
phonetically realized syllable types; and
articulatory gestures.

14. The multi-platform visual pronunciation dictionary according to claim 12, wherein the synchronized video and audio recording files comprise recordings of lexical items, the lexical items being words and phrases.

15. The multi-platform visual pronunciation dictionary according to claim 12, wherein the synchronized video and audio recording files comprise recordings of linguistic types capable of being isolated at a phonological-morphological interface.

16. The multi-platform visual pronunciation dictionary according to claim 12, wherein the synchronized video and audio recording files comprise recordings of sub-lexical units selected from the group consisting of morpho-phonemics, morpho-syllabics, phono-tactics, grammatical inflection, and lexical derivation.

17. The multi-platform visual pronunciation dictionary according to claim 12, wherein the synchronized video may comprise a still visual representation of the audio recording file.

18. The multi-platform visual pronunciation dictionary according to claim 12, wherein the database comprises an entire described lexicon of a language.

19. The multi-platform visual pronunciation dictionary according to claim 12, wherein the database is a relational database and capable of being limited to subsets of types and tokens in a searchable and accessible master list reflecting a predetermined linguistic/pedagogical principle.

20. The multi-platform visual pronunciation dictionary according to claim 12, further comprising a vocabulary study module having a vocabulary study template means for providing remedial reading and word study, including phonetic spellings, syllabic breaks with stress/pitch marks, bilingual translation, monolingual definitions, synonyms, antonyms, polysemy, key collocations, patterns, examples of inflectional and derivational morphology, and example idioms, phrases, and sentences.

21. The multi-platform visual pronunciation dictionary according to claim 12, further comprising means for presenting the native speaker recording in split screen with a user for comparing mouth movements of the native speaker to mouth movements of the user in real time in order to provide the user a feedback language learning experience.

22. The multi-platform visual pronunciation dictionary according to claim 12, further comprising means for presenting the native speaker recording in a transparent overlay with a user for comparing mouth movements of the native speaker to mouth movements of the user in real time in order to provide the user a feedback language learning experience.
